(19) United States
(12) Patent Application Publication
(10) Pub. No.: US 2012/0020349 A1
(43) Pub. Date: Jan. 26, 2012

(54) ARCHITECTURE FOR A ROBUST COMPUTING SYSTEM

(75) Inventors: John Craig Dunwoody, Belmont, CA (US); Teresa Ann Dunwoody, Belmont, CA (US)

(73) Assignee: GraphStream Incorporated

(21) Appl. No.: 12/840,842

(22) Filed: Jul. 21, 2010

(51) Int. Cl. G06F 15/16; H04L 12/28

(52) U.S. Cl. 370/351; 709/250

(57) ABSTRACT

A computer system may include N rack unit switches and 6N processing rack units, where N is a positive integer. Each rack unit switch may include four switching units and each switching unit may include at least M²/2 ports. Each processing rack unit may include at least 27*4N ports originating from a plurality of processing modules of each respective processing rack unit. The ports of the N rack unit switches may be coupled to the ports of the 6N processing rack systems to create a network architecture.

### RELATED APPLICATIONS

This application is related to application Ser. Nos. ______, ______, ______, ______, ______, each filed ______, 200______, and incorporated herein by reference in their entirety.

### FIELD

This application relates to an architecture for interconnecting a plurality of rack mounted processing systems.

### BACKGROUND

Current standard rack configurations are measured in rack-units (RUs). For example, a blade server may have a rack unit measuring 19 inches wide and having a pitch of 1.75 inches in height. A common computer rack form-factor is 42 RU high, which is a factor in limiting the density or number of components directly mountable into a rack. Higher density component systems are desirable since they require less space per rack enclosure and ultimately less space within the building housing the enclosures. Often these buildings must include high price high maintenance false floors to accommodate the mass of cabling and the delivery of chilled air and power to the enclosures. Another factor in determining component density is the pitch of the rack unit as often limited by the space required for component heat sinks and associated cooling components (e.g., fans).

Of particular concern is the cooling of the rack's components. During operation, the electrical components produce heat, which a system must displace to ensure the proper functioning of its components. In addition to maintaining normative function, various cooling methods, such as liquid or air cooling, are used to either achieve greater processor performance (e.g., overclocking), or to reduce the noise pollution caused by typical cooling methods (e.g., cooling fans and heat sinks). A frequently underestimated problem when designing high-performance computer systems is the discrepancy between the amount of heat a system generates, particularly in high performance and high density enclosures, and the ability of its cooling system to remove the heat uniformly throughout the rack enclosure.

In many applications in which a large amount of processing power and other computing resources are desired, a plurality of the racks described above may be chained together to provide increased capacity. As the ability to cool components increases and the ability to create racks with a high density of functional modules, the ability to provide massive amounts of processing capability is possible by interconnecting such racks. However, the interconnection of numerous racks with numerous different processing modules in an environment that fosters communication among the modules may be prohibitively complex.

### SUMMARY

In one embodiment, a computer system is provided. The computer system may include N rack unit switches and 6N processing rack units, where N is a positive integer. Each rack unit switch may include four switching units and each switching unit may include at least M²/2 ports. Each processing rack unit may include at least 27*4N ports originating from a plurality of processing modules of each respective processing rack unit. The ports of the N rack unit switches may be coupled to the ports of the 6N processing rack systems to create a network architecture.

### BRIEF DESCRIPTION OF THE DRAWINGS

The present invention is illustrated by way of example, and not by way of limitation, in the figures of the accompanying drawings in which:

FIG. 1 illustrates an embodiment of a rack system including a cooled universal hardware platform;

FIG. 2 illustrates a portion of the side of the rack system and the cooled universal hardware platform, according to one embodiment;

FIG. 3 illustrates an embodiment of rack system and specifically the rear portion and the open side of the rack and the cooled universal hardware platform;

FIG. 4 illustrates a block diagram of a cluster switch according to an exemplary embodiment;

FIG. 5 illustrates a block diagram of a gateway card according to an exemplary embodiment;

FIG. 6 illustrates a block diagram of a processing module according to an exemplary embodiment;

FIG. 7 illustrates a block diagram of a rack management module according to an exemplary embodiment;

FIG. 8 illustrates a block diagram of a rack power module according to an exemplary embodiment;

FIG. 9 illustrates an embodiment of a cooled partition found within the rack system;

FIG. 10 illustrates an embodiment of several cooled partitions making up the module bays as viewed outside of the rack system;

FIGS. 11 and 12 illustrate embodiments of a module fixture that includes circuit cards and components that make up a functional module in a service unit;

FIGS. 13 and 14 illustrate embodiments of the module fixture from a side view in a compressed and uncompressed state respectively;

FIGS. 15 and 16 illustrate embodiments of a module fixture for a rack power board insertable into the rack power section of the rack system;

FIG. 17 illustrates a block diagram of a rack power module according to an example embodiment;

FIG. 18 illustrates an example architecture of a switch unit according to an example embodiment; and

FIG. 19 illustrates a potential topology of the switch unit according to an example embodiment; and

FIG. 20 illustrates a potential topology for connection of twenty-four rack units via the four rack unit switches according to an example embodiment.

### DETAILED DESCRIPTION

Although an embodiment of the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

Embodiments of the present invention generally relate to an architecture for a scalable modular data system. In this regard, embodiments of the present invention relate to a rack system (e.g., rack system 10) that may contain a plurality of service units or modules. The rack system described herein provides physical support, power, and cooling for the service units or modules contained therein. The rack system also provides a set of interfaces for the service units or modules including mechanical, thermal, electrical, and communication protocol specifications. Moreover, the rack system described herein may be easily networked with a plurality of instances of other rack systems to create the highly scalable modular architecture referenced above.

Each service unit or module that may be housed in the rack system provides some combination of processing, storage, and communication capacity enabling the service units to provide functional support for various computing, data processing and storage activities (e.g., as servers, storage arrays, network switches, etc.). However, embodiments of the present invention provide a mechanical structure for the rack system and the service units or modules that provides for efficient heat removal from the service units or modules in a compact design. Thus, the amount of processing capability that can be provided for a given amount of energy consumption may be increased.

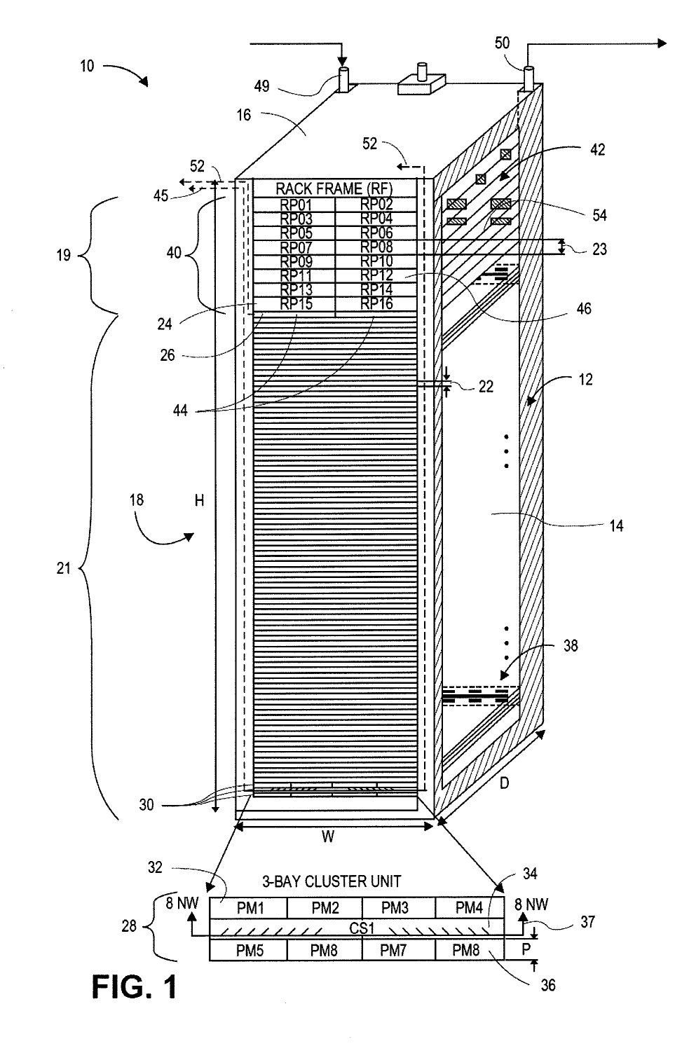

FIG. 1 illustrates an embodiment of a rack system 10. Rack system 10 includes a rack power section 19 and a universal hardware platform 21. The universal hardware platform 21 includes a universal backplane mounting area 14. The rack system 10 has a perimeter frame 12 having a height ‘H’ width ‘W’ and depth ‘D.’ In one embodiment, the perimeter frame 12 includes structural members around the perimeter of the rack system 10 and is otherwise open on each vertical face. In other embodiments some or all of the rack's faces or planes may be enclosed, as illustrated by rack top 16.

The front side of the rack, rack front 18, may include a multitude of cooled partitions substantially parallel to each other and at various pitches, such as pitch 22 (P), where the pitch may be equal to the distance between the first surface of one cooled partition to the second surface of an adjacent cooled partition. The area or volume between each partition defines a module bay, such as module bay 24 or module bay 26. Each module bay may have a different size based on their respective pitches, such as pitch 22 corresponding to module bay 26 and pitch 23 corresponding to module bay 24. It can be appreciated that the pitch may be determined any number of ways, such as between the mid lines of each partition or between the inner surfaces of two consecutive partitions. In one embodiment, the pitch 22 is a standard unit of height, such as 0.75 inches, and variations of the pitch, such as pitch 23, may be a multiple of the pitch 23. For example, pitch 23 is two times the pitch 22, where pitch 22 is the minimum pitch based on module or other design constraints.

The rack system 10, and specifically the universal hardware platform 21, may be configured to include a multitude of service units. Each service unit may provide a combination of data processing capacity, data storage capacity, and data communication capacity. In one embodiment the rack system 10 provides physical support, power, and cooling for each service unit that it contains. A service unit and its corresponding service unit backplane correspond to a rack unit model. The rack unit model defines a set of interfaces for the service unit, which include mechanical, thermal, electrical, and communication-protocol specifications. Thus, any service unit that conforms to the interfaces defined by a particular rack unit model may be installed and operated in a rack system that includes the corresponding service unit backplane. For example, the service unit backplane mounts vertically to the universal backplane mounting area 14 and provides the connections according to the rack unit model for all of the modules that perform the functions of the service unit.

Cluster unit 28 is an example of a service unit configured to provide processing and switching functions to sixteen data nodes. In this embodiment, the cluster unit 28 spans over three module bays, module bays 30, and includes eight processing modules and a cluster switch. Specifically, the cluster unit 28 includes the four processing modules 32 (PM1-PM4) in the first module bay, a cluster switch 34 (CS1) in the second module bay, and the remaining processing modules 36 (PM5-PM8) in the third module bay.

Each of these modules may slide into their respective slots with the module bay and connect into a service unit backplane, such as cluster unit backplane 38. The cluster unit backplane 38 may be fastened to the perimeter frame 12 in the universal backplane mounting area 14. The combination of the cluster switch 34 and the cluster unit backplane 38 in this embodiment has the advantage of signal symmetry, where the signal paths of the processing modules 32 and 36 are equidistant to the cluster switch 34.

In one embodiment, the cluster switch 34 has 8 network lines exiting out of the front of the cluster switch 34 at a forty-five degree angle toward each side of the rack front 18, see for example network lines 37. For simplicity, only one cluster switch (e.g., cluster switch 34) is shown, however it can be appreciated that a multitude of cluster switches may be included in the rack system 10. Thus, the network lines for every installed cluster switch may run up the perimeter frame 12 and exit the rack top 16 in a bundle, as illustrated by net 52.

In various embodiments, some or all of the service units, such as the cluster unit 28 including the processing modules 32 and the cluster switch 34, are an upward-compatible enhancement of mainstream industry-standard high performance computing (HPC)-cluster architecture, with x86_{—}64 instruction set architecture (ISA) and standard Infiniband networking interconnects. This enables one hundred percent compatibility with existing system and application software used in mainstream HPC cluster systems and is immediately useful to end-users upon product introduction, without extensive software development or porting. Thus, implementation of these embodiments includes using commercial off the shelf (COTS) hardware and firmware whenever possible, and does not include any chip development or require the development of complex system and application software. As a result, these embodiments dramatically reduce the complexity and risk of the development effort, improve energy efficiency, and provide a platform to enable application development for concurrency between simulation and visualization computing to thereby reducing data-movement bottlenecks. The efficiency of the architecture of the embodiments applies equally to all classes of scalable computing facilities, including traditional enterprise-datacenter server farms, cloud/utility computing installations, and HPC clusters. This broad applicability maximizes the ability for significant improvements in energy and environmental efficiency of computing infrastructures. However, it should be noted that custom circuit and chip designs could also be used in the disclosed rack system design, but would not likely be as cost effective as using COTS components.

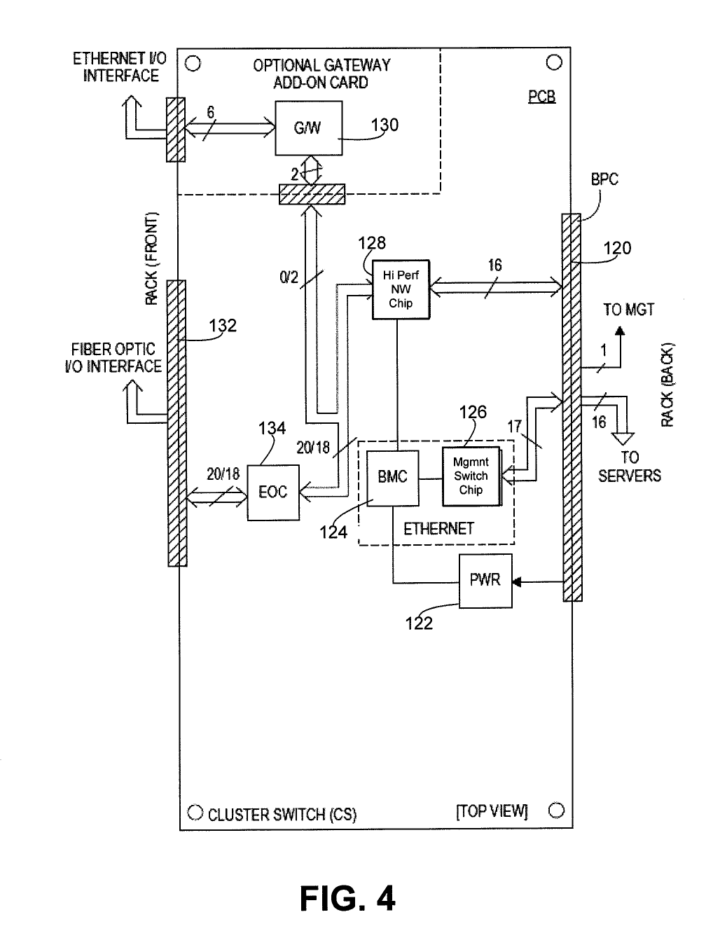

A diagram showing a cluster switch according to an example embodiment is provided in FIG. 4. In this regard, the cluster switch may include a backplane connector (BPC) 120 that may connect the cluster switch 34 to the cluster unit backplane 38. In some embodiments, the BPC 120 may include at least sixteen ports to connect to other servers or rack systems and one port for a connection to a higher level management module. A power module 122 may be coupled to the BPC 120 to enable information on power status of the power module 122 to be shared with other modules or rack systems. The power module 122 may be in communication with a baseboard management controller (BMC) 124 that may be configured to enable communications (e.g., via Ethernet) with other modules or rack systems to inquire about or answer inquiries regarding power status, temperature or other conditions for various modules. The BMC 124 may, along with a management switch chip 126 (e.g., an Ethernet switch), enable Ethernet or other communications to other servers or modules via the BPC 120. In an example embodiment, the BPC 120 may also be coupled to a high performance network chip 128 (e.g., an Infiniband chip). The high performance network chip 128 may be a standard thirty six pin chip and include sixteen pins assigned to communication with other servers or modules of the rack system 10 via the BPC 120 with some or all of the remaining twenty pins being assigned to communication with external networks (e.g., via Ethernet) and/or with other rack systems. In an example embodiment, zero to two pins may be used for connection to an optional gateway card 130. The gateway card 130 may then connect to an Ethernet or other input/output interface to external networks. The other eighteen to twenty pins may be coupled to a fiber optic input/output interface 132 to connect to other rack systems. In some embodiments, the other eighteen to twenty pins may be connected to the fiber optic input/output interface 132 via an optional electro-optic converter 134.

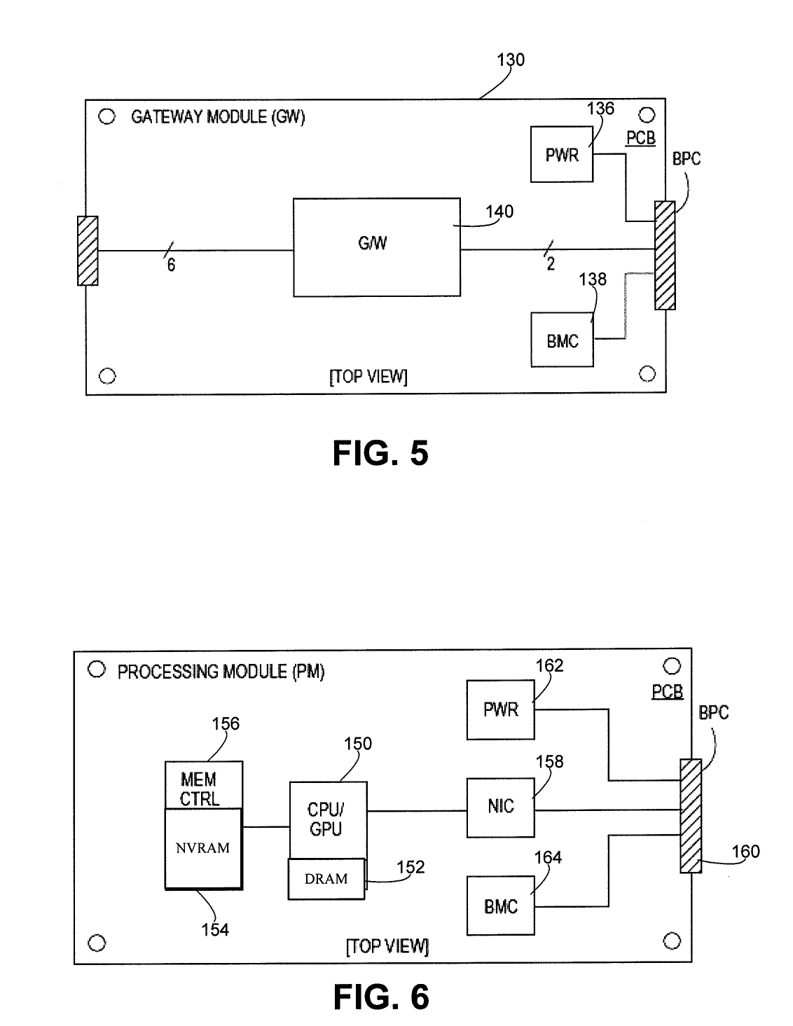

FIG. 5 illustrates an example of the gateway card according to an exemplary embodiment. As shown in FIG. 5, the gateway card 130 may also include a power module 136 and a baseboard management controller (BMC) 138 that may operate similar to the corresponding power module 122 and BMC 124 described above. The gateway card 130 may also include a gateway chip 140 providing a connection to external networks (e.g., via Ethernet connection).

FIG. 6 illustrates an example of a processing module according to an exemplary embodiment. As shown in FIG. 6, the processing module may include a processor 150 and volatile and non-volatile memory (e.g., DRAM 152 and NVRAM 154) that may be controlled by a memory controller 156. The processor 150 may be in communication with a network interface chip (NIC) 158 that may be a high performance network chip such as an Infiniband chip. The NIC 158 may provide an input to a backplane connector (BPC) 160 that may be configured to enable the processing module to be mounted to the cluster unit backplane 38. The processing module may also include a power module 162 and a baseboard management controller (BMC) 164 that may operate similar to the corresponding power module 122 and BMC 124 described above.

Returning to the discussion of FIG. 1, the cluster unit backplane 38 may be a single circuit board with connectors corresponding to their counterpart connectors on each module of the cluster unit 28, and the cluster unit backplane 38 may have a height of approximately the height of the (three) module bays 30. In other embodiments, the cluster unit backplane 38 may be composed of two or more circuit boards with corresponding connectors, or the cluster unit backplane 38 may be single circuit board that supports two or more cluster units (e.g., cluster unit 28) over a multitude of module bays.

The optional rack power section 19 of the rack system 10 may include rack power and management unit 40 composed of two rack management modules 44 and a plurality of rack power modules 46 (e.g., RP01-RP16). In another embodiment, the rack management modules 44 and a corresponding rack management backplane (not shown) may be independent of the rack power unit 40 and may be included in the universal hardware platform 21. In one embodiment, there may be two modules per module bay, such as the two rack power modules in module bay 24 and the two rack management modules 44 in module bay 26.

The rack management modules 44 may provide network connectivity to every module installed in the rack system 10. This includes every module installed in the universal hardware platform 21 and every module of the rack power section 19. Management cabling 45 provides connectivity from the rack management modules 44 to devices external to the rack system 10, such as networked workstation or control panel (not shown). This connectivity may provide valuable diagnostic and failure data from the rack system 10 and in some embodiments provide an ability to control various service units and modules within the rack system 10.

As with the backplane boards of the universal hardware platform 21, the back plane area corresponding to the rack power section 19 may be utilized to fasten one or more backplane boards. In one embodiment, a rack power and management backplane 42 is a single backplane board with connectors corresponding to their counterpart connectors on each of the rack management modules 44 and the rack power modules 46 of the rack power and management unit 40. The rack power and management backplane 42 may then have a height of approximately the height of the collective module bays corresponding to the rack power and management unit 40. In other embodiments, the rack power and management backplane 42 may be composed of two or more circuit boards with corresponding connectors.

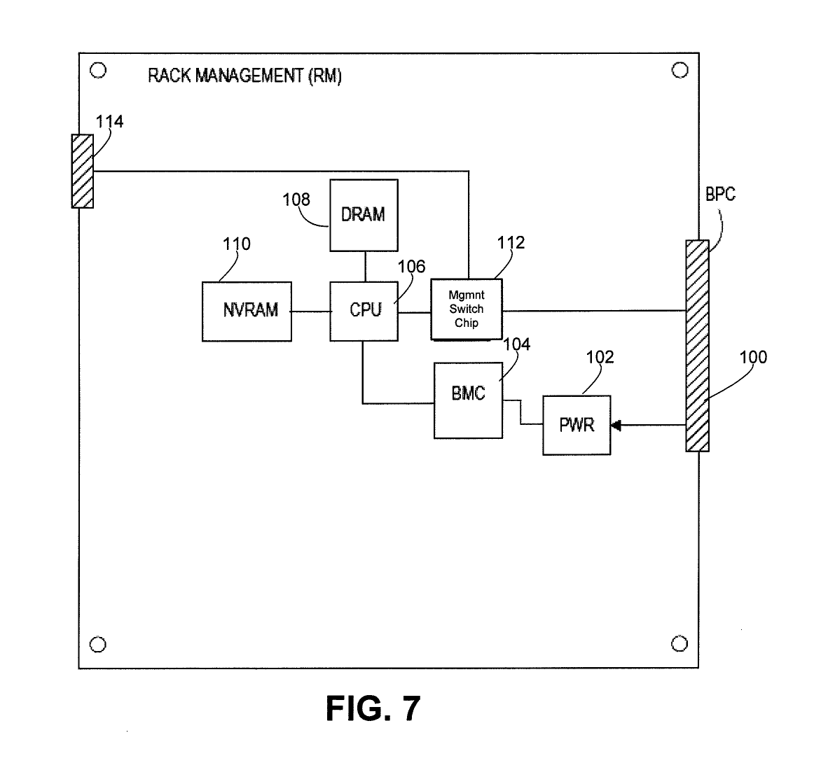

The rack management module 44 of one example embodiment is shown in FIG. 7. As shown in FIG. 7, the rack management module 44 may include a backplane connector (BPC) 100 that connects the rack management module 44 to the rack power and management backplane 42. A power module 102 may be coupled to the BPC 100 to enable information on power status of the power module 102 to be shared with other modules or rack systems. The power module 102 may be in communication with a baseboard management controller (BMC) 104 that may be configured to enable communications (e.g., via Ethernet) with other modules or rack systems to inquire about or answer inquiries regarding power status, temperature or other conditions for various modules. The BMC 104 may be in communication with a processor (or CPU) 106 that may issue commands to rack service modules to manage operations of the rack system 10 (and/or cooperation with other rack systems). As such, for example, the processor 106 may be enabled to turn modules on or off, get information on module temperature, or acquire other information regarding module conditions and/or performance. The processor 106 may have access to volatile and/or non-volatile memory (e.g., DRAM 108 and NVRAM 110) and may be in communication with a management switch chip 112 (e.g., an Ethernet switch). The management switch chip 112 may be coupled to the BPC 100 (e.g., via 48 point to point connection pins) and/or external management devices (e.g., a higher level management computer) via an external link 114 (e.g., at the front of the module instead of at the back end).

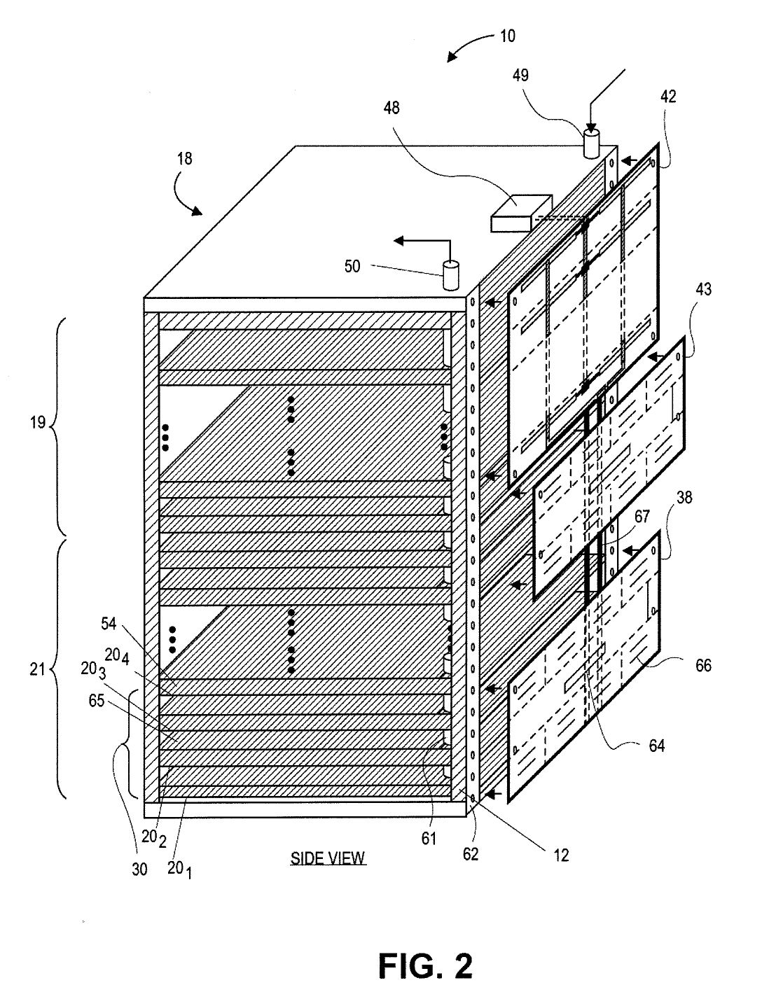

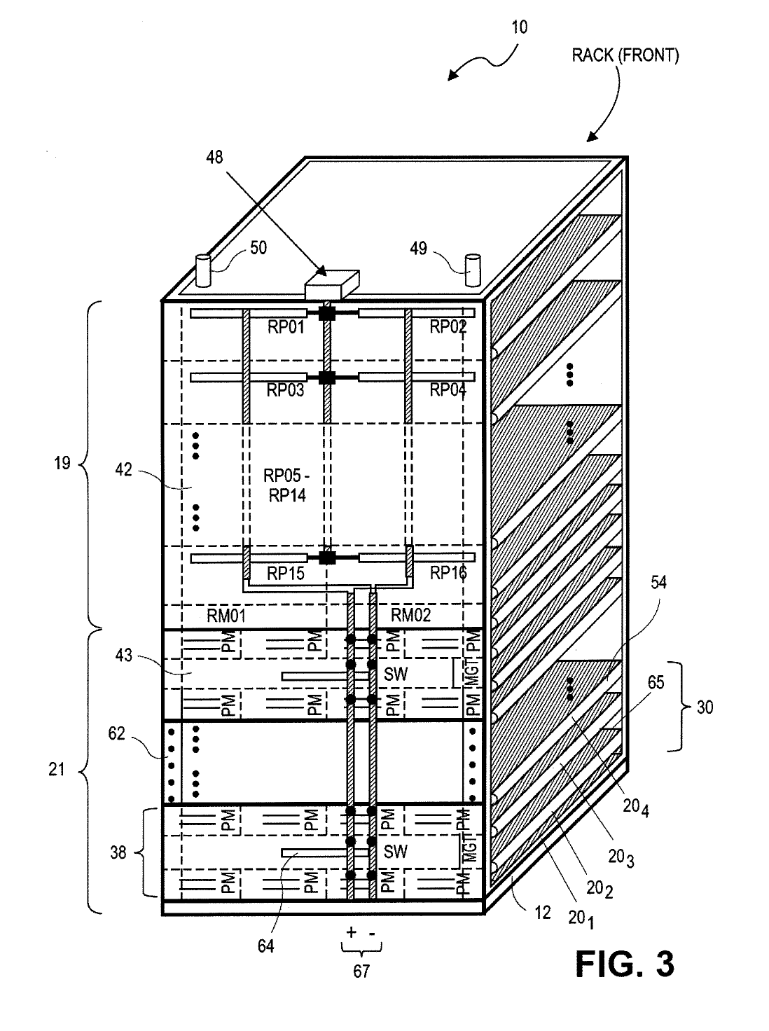

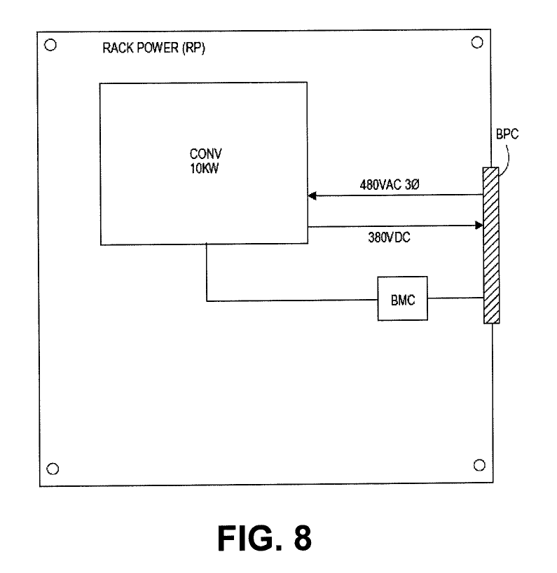

In one embodiment, the rack power modules 46 are connected to the power inlet 48 (See e.g., FIGS. 2 and 3), which may be configured to receive three-phase alternating current (AC) power from a source external to the rack system 10. The rack power modules 46 convert the three-phase AC into direct current (DC). For example, the rack power modules 46 may convert a 480 volt three-phase AC input to 380 volt DC for distribution in the rack system 10. FIG. 8 illustrates a block diagram of a rack power module according to an example embodiment. In this regard, the rack power module of FIG. 8 includes a backplane connector (BPC) that connects the rack power module to the backplane. The rack power module also includes a power converter for converting 480 volt three-phase AC input to 380 volt DC and a baseboard management controller (BMC) that enables the rack power module to be addressed via the Ethernet for power status inquiries, temperature inquiries and other requests. In one embodiment, the DC voltage from the rack power modules 46 is connected to power bus 67 (See e.g., FIGS. 2 and 3) running down from the rack power and management backplane 42 to other service unit backplanes, such as the cluster unit backplane 38.

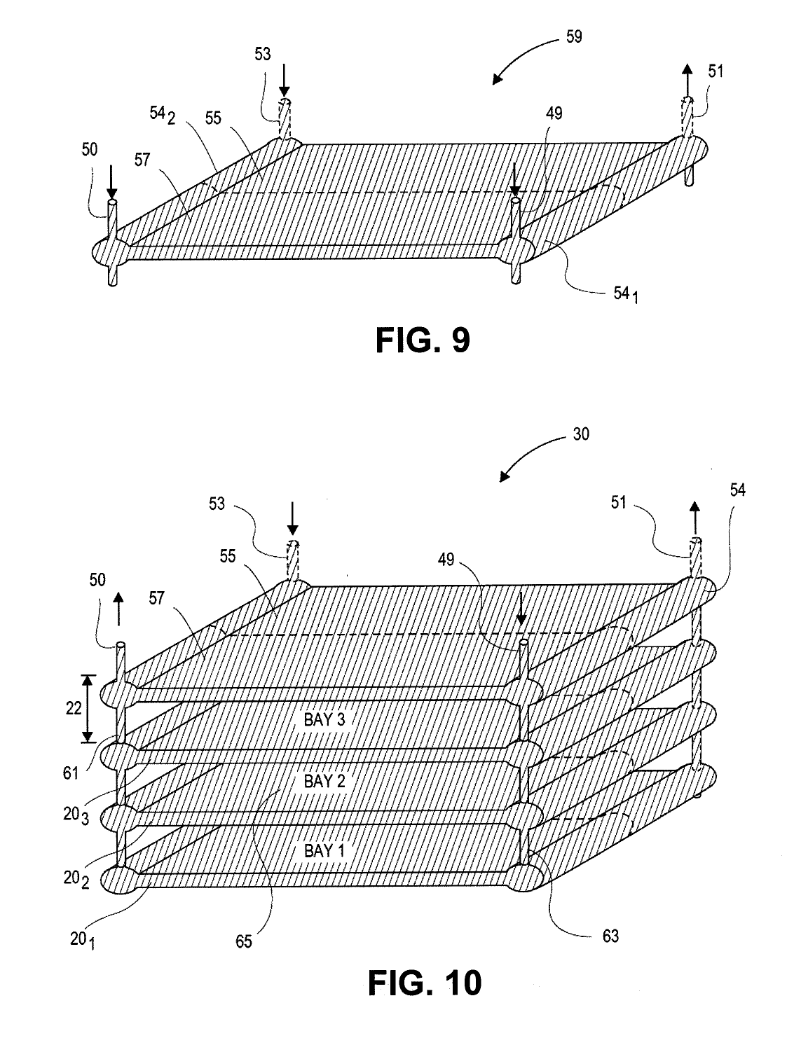

The rack system 10 may include a coolant system having a coolant inlet 49 and coolant outlet 50. The coolant inlet 49 and the coolant outlet 50 are connected to piping running down through each partition's coolant distribution nodes (e.g., coolant distribution node 54) to provide the coolant into and out of the cooled partitions. For example, coolant (refrigerant R-134a) flows into the coolant inlet 49, through a set of vertically spaced, 0.1 inch thick horizontal cooled partitions (discussed below with reference to FIGS. 3 and 9) and out of the coolant outlet 50. As discussed above, the space between each pair of adjacent cooled partitions is a module bay. Waste heat is transferred via conduction, first from the components within each module (e.g., processing modules 32) to the module's top and bottom surfaces, and then to the cooled partitions at the top and bottom of the module bay (e.g., module bays 30). Other coolant distribution methods and hardware may also be used without departing from the scope of the embodiments disclosed herein.

Thus, embodiments of the rack system 10 including one or all of the compact features based on modularity, cooling, power, pitch height, processing, storage and networking provide, among others, energy efficiency in system manufacturing, energy efficiency in system operation, cost efficiency in system manufacturing and installation, cost efficiency in system maintenance, space efficiency of system installations, and environmental impact efficiency throughout the system lifecycle.

FIG. 2 illustrates a portion of the side of the rack system 10, according to one embodiment. FIG. 2 shows the rack power section 19 and the universal hardware platform 21 as seen form an open side and rear perspective of the rack system 10. The three module bays of the module bays 30 are made up of four cooled partitions, cooled partitions 20₁, 20₂, 20₃, and 20₄. Each module bay includes two partitions, in this embodiment an upper and a lower partition. For example, module bay 65 is the middle module bay of the three module bays, module bays 30, and has cooled partition 20₂ as the lower cooled partition and 20₃ as the upper cooled partition. As will be discussed in further detail below, functional modules may be inserted into module bays, such as module bay 65, and thermally couple to the cooled partitions to cool the modules during operation.

The coolant distribution node 54 is illustrated on cooled partition 20₄, and in this embodiment, is connected to the coolant distribution nodes of other cooled partitions throughout the rack via coolant pipe 61 running up the height of the rack and to the coolant outlet 50. Similarly, coolant pipe 63 (See e.g., FIG. 10) is connected to the opposite end of each of the cooled partitions at a second coolant distribution node and the coolant inlet 49.

The perimeter frame 12 of the rack system 10 may include a backplane mounting surface 62 where the service unit backplanes are attached to the perimeter frame 12, such as the cluster unit backplanes 38 and 43 of the universal hardware platform 21, and the rack power and management backplane 42 of the rack power section 19. In various embodiments, the backplane mounting surface 62 may include mounting structures that conform to a multiple of a standard pitch size (P), such as pitch 22 shown in FIG. 1. The mounting structures on the surface of the service unit backplanes as well as the backplanes themselves may be configured to also conform with the standard pitch size. For example, the cluster unit backplane 38 may have a height of approximately the height of module bays 30 corresponding to a pitch of 3P, and accordingly the structures of the backplane mounting surface 62 are configured to align with the mounting structures of the cluster unit backplane 38.

In various embodiments, the mounting structures for the backplane mounting surface 62 and the service units (e.g., cluster unit 28) may be magnetic, rails, indentations, protrusions, bolts, screws, or uniformly distributed holes that may be threaded or configured for a fastener (e.g., bolt, pin, etc.) to slide through, attach or snap into. Embodiments incorporating the mounting structures set to a multiple of the pitch size have the flexibility to include a multitude of backplanes corresponding to various functional types of service units that may be installed into the module bays of the universal hardware platform 21 of the rack system 10.

When mounted, the service unit backplanes provide a platform for the connectors of the modules (e.g., processing modules 36 of service unit 28) to couple with connectors of the service unit backplane, such as the connectors 64 and 66 of the cluster unit backplane 38 and the connectors associated with the modules of cluster unit 28 described above. The connectors are not limited to any type and may be, for example, an edge connector, pin connector, optical connector, or any connector type or equivalent in the art. Because multiple modules may be installed into a single module bay, the cooled partitions may include removable, adjustable or permanently fixed guides (e.g., flat brackets or rails) to assist with the proper alignment of the modules with the connectors of the backplane upon module insertion. In another embodiment, a module and backplane may include a guide pin and corresponding hole (not shown), respectively, to assist in module alignment.

FIG. 3 is an embodiment of rack system 10 illustrating the rear portion and the open side of the rack. As shown, FIG. 3 only represents a portion of the entire rack system 10, and specifically, only portions of the rack power section 19 and the universal hardware platform 21. This embodiment illustrates the power inlet 48 coupled to a power bus 67 via the rack power and management backplane 42, which as previously mentioned may convert AC power from the power inlet 48 to DC power for distribution to the service units via the service unit backplanes of the universal hardware platform 21.

In one embodiment, the power bus 67 includes two solid conductors; a negative or ground lead and a positive voltage lead connected to the rack power and management backplane 42 as shown. The power bus 67 may be rigidly fixed to the rack power and management backplane 42 or may only make electrical connection but be rigidly fixed to the backplanes as needed, such as the cluster unit backplanes 38 and 43. In another embodiment where DC power is supplied directly to the power inlet 48, the power bus 67 may be insulated and rigidly fixed to the rack system 10. Regardless of the embodiment, the power bus 67 is configured to provide power to any functional type of backplane mounted in the universal hardware platform 21. The conductors of the power bus 67 may be electrically connected to the service unit backplanes by various connector types. For example, the power bus 67 may be a metallic bar which may connect to each backplane using a bolt and a clamp, such as a D-clamp.

FIG. 3 also illustrates another view of the cooled partitions of the rack system 10. This embodiment shows the coolant distribution node 54 that is part of the cooled partitions shown, such as the cooled partitions 20₁, 20₂, 20₃, and 20₄ of module bays 30, and also shows a side view of the middle module bay, module bay 65. As discussed above, the coolant distribution node 54 may be connected to the coolant distribution nodes of the other cooled partitions via coolant pipes 61 and 63 (see e.g., FIGS. 2 and 10) running up the rack and to the coolant inlet 49 and the coolant outlet 50.

FIG. 9 is an embodiment of a cooled partition 59. The cooled partition 59 includes coolant distribution nodes 54₁ and 54₂, which are connected to the coolant inlet 49 and the coolant outlet 50, respectively. The cooled partition 59 internally includes channels (not shown) that facilitate coolant flow between each coolant distribution node 54₁ and 54₂ to cool each side of the cooled partition 59. The internal channels may be configured in any suitable way known in the art, such as a maze of veins composed of flattened tubing, etc. The coolant distribution nodes 54₁ and 54₂ may include additional structures to limit or equalize the rate and distribution of coolant flow along the each axis of the coolant distribution node and through the cooled partition. Additionally, the coolant inlet 49 and the coolant outlet 50 may be caddy-corner or diagonal to each other depending on the rack design and the channel design through the cooled partition 59.

In another embodiment, the cooled partition 59 may be divided into two portions, partition portion 55 and partition portion 57. Partition portion 57 includes existing coolant inlet 49 and coolant outlet 50. However, the partition portion 55 includes its own coolant outlet 51 and coolant inlet 53. The partition portions 55 and 57 may be independent of each other and have their own coolant flow from inlet to outlet. For example, the coolant flow may enter into coolant inlet 49 of partition portion 57, work its way through cooling channels and out to the coolant outlet 50. Similarly, coolant flow may enter coolant inlet 53 of partition portion 55, through its internal cooling channels and out of coolant outlet 51. In another embodiment, the coolant inlet 49 and the coolant inlet 53 may be on the same side of the partition portion 55 and the partition portion 57, respectively. Having the coolant inlets and outlets on opposite corners may have beneficial cooling characteristics in having a more balanced heat dissipation throughout the cooled partition 59.

In another embodiment, the partition portions 55 and 57 are connected such that coolant may flow from one partition portion to the next either through one or both of the coolant distribution nodes 54₁ and 54₂ and through each partition portions' cooling channels. In this embodiment, based on known coolant flow characteristics, it may be more beneficial to have the coolant inlet 49 and the coolant inlet 53 on the same side of the partition portion 55 and the partition portion 57, and similarly the outlets 50 and 51 on the side of the partition portions 55 and 57.

FIG. 10 is an embodiment of the cooled partitions 20₁, 20₂, 20₃, and 20₄ of module bays 30 outside of the rack system 10 and provides another illustration of the module bay 65. Each cooled partition may have the same functionality as described in FIG. 9 with respect to cooled partition 59. Each cooled partition is physically connected by the coolant pipe 61 and the coolant pipe 63, which provide system wide coolant flow between all cooled partitions within the rack system 10. As with the cooling partition 59 of FIG. 9, in another embodiment the cooled partitions 20₁, 20₂, 20₃, and 20₄ may have an additional coolant outlet 51 and coolant inlet 53 and associated piping similar to coolant pipes 61 and 63. In other embodiments, the configuration of the inlets and outlets may vary depending on the desired coolant flow design. For example, the two inlets may be on opposite diagonal corners or on the same side depending on the embodiment designed to, such as including partition portions, etc., as discussed above with reference to FIG. 9.

In one embodiment, the bottom and top surfaces of the cooled partitions 20₁, 20₂, 20₃, and 20₄ are heat conductive surfaces. Because coolant flows between these surfaces they are suited to conduct heat away from any fixture or apparatus placed in proximity to or in contact with either the top or bottom surface of the cooled partitions, such as the surfaces of cooled partitions 20₂ and 20₃ of module bay 65. In various embodiments, the heat conductive surfaces may be composed of many heat conductive materials known in the art, such as aluminum alloy, copper, etc. In another embodiment, the heat conductive surfaces may be a mixture of heat conducting materials and insulators, which may be specifically configured to concentrate the conductive cooling to specific areas of the apparatus near or in proximity to the heat conductive surface.

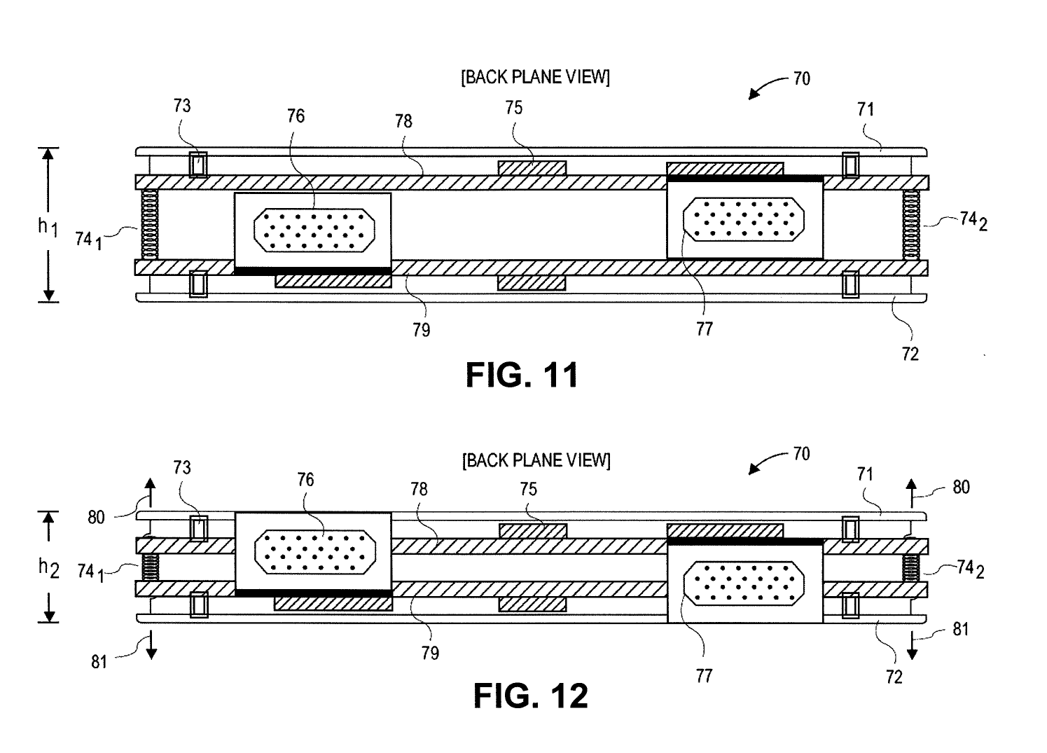

FIGS. 11 and 12 are each embodiments of a module fixture 70 that may include circuit cards and components that make up a functional module in a service unit, such as the four processing modules 32 insertable into the module bay 65 as discussed with reference to FIGS. 1, 2, and 10. The module fixture 70 includes thermal plates 71 and 72, fasteners 73, tensioners 74₁ and 74₂, component 75, connector 76, connector 77, and component boards 78 and 79.

In one embodiment, the component boards 78 and 79 are a multi-layered printed circuit board (PCB) and are configured to include connectors, nodes and components, such as component 75, to form a functional circuit. In various embodiments, the component board 78 and the component board 79 may have the same or different layouts and functionality. The component boards 78 and 79 may include the connector 77 and the connector 76, respectively, to provide input and output via a connection to the backplane (e.g., cluster unit backplane 38) through pins or other connector types known in the art. Component 75 is merely an example component and it can be appreciated that a component board may include many various size, shape, and functional components that still may receive the unique benefits of the cooling, networking, power and form factor of the rack system 10.

The component board 78 may be mounted to the thermal plate 71 using fasteners 73 and, as discussed below, will be in thermal contact with at least one and preferably two cooled partitions when installed into the rack system 10. In one embodiment, the fasteners 73 have a built in standoff that permits the boards' components (e.g., component 75) to be in close enough proximity to the thermal plate 71 to create a thermal coupling between the component 75 and at least a partial thermal coupling to the component board 78. In one embodiment the component board 79 is opposite to and facing the component board 78 and may be mounted and thermally coupled to the thermal plate 72 in a similar fashion as component board 78 to thermal plate 71.

Because of the thermal coupling of the thermal plates 71 and 72—which are cooled by the cooling partitions of the rack system 10—and the components of the attached boards, (e.g., component board 78 and component 75) there is no need to attach a heat-dissipating component, such as a heat sink, to the components. This allows the module fixture 70 to have a low profile permitting a higher density or number of module fixtures, components, and functionality in a single rack system, such as the rack system 10 and in particular the portion that is the universal hardware platform 21.

In another embodiment, if a component height is sufficiently higher than another component mounted on the same component board, the lower height component may not have a sufficient thermal coupling to the thermal plate for proper cooling. In this case, the lower height component may include a heat-dissipating component to ensure an adequate thermal coupling to the thermal plate.

In one embodiment, the thermal coupling of the thermal plates 71 and 72 of the module fixture 70 is based on direct contact of each thermal plate to their respective cooled partitions, such as the module bay 65 which include cooled partitions 20₃ and 20₄ shown in FIGS. 2, 3, and 10 above. To facilitate the direct contact, thermal plates 71 and 72 may each connect to an end of a tensioning device, such as tensioners 74₁ and 74₂. In one embodiment, the tensioners are positioned on each side and near the edges of the thermal plates 71 and 72. For example, tensioners 74₁ and 74₂ may be springs in an uncompressed state resulting in a module fixture height h₁, as shown in FIG. 11, where h₁ is larger than the height of the module bay 65 including cooled partitions 20₃ and 20₄.

FIG. 12 illustrates the module fixture 70 when the thermal plates 71 and 72 are compressed towards each other to a height of h₂, where h₂ is less than or equal to the height or distance between the cooled partitions 20₃ and 20₄ of the module bay 65. Thus, when the module fixture is inserted into the module bay 65 there is an outward force 80 and an outward force 81 created by the compressed tensioners 74₁ and 74₂. These outward forces provide a physical and thermal contact between the cooled partitions 20₃ and 20₄ and the thermal plates 71 and 72. As coolant flows through each partition, as described with respect to FIG. 10, it conductively cools the boards and components of the module fixture 70.

The tensioners 74₁ and 74₂ may be of any type of spring or material that provides a force creating contact between the thermal plates and the cooling partitions. The tensioners 74₁ and 74₂ may be located anywhere between the thermal plates 71 and 72, including the corners, the edges or the middle, and have no limit on how much they may compress or uncompress. For example, the difference between h₁ and h₂ may be as small as a few millimeters or as large as several centimeters. In other embodiments, the tensioners 74₁ and 74₂ may pass through the mounted component boards or be between and couple to the component boards or any combination thereof. The tensioners may be affixed to the thermal plates or boards by any fastening hardware, such as screws, pins, clips, etc.

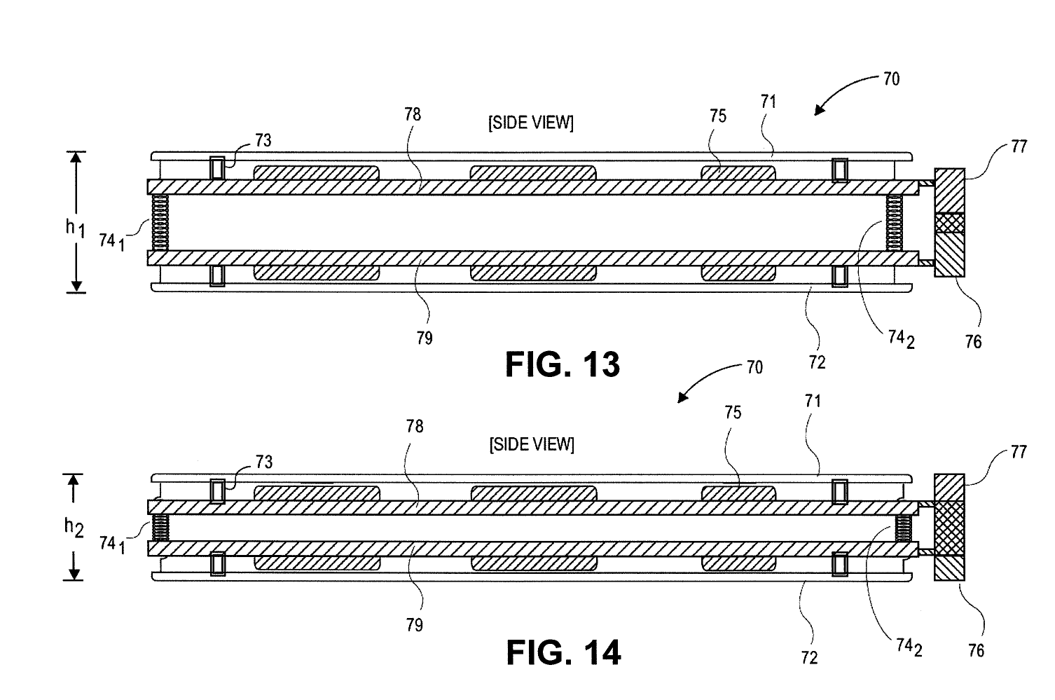

FIGS. 13 and 14 are embodiments of the module fixture 70 from a side view in a compressed and uncompressed state respectively. As shown in FIGS. 11 and 12 the connectors 76 and 77 do not overlap, and in this embodiment, are on different sides as seen from the back plane view. FIGS. 13 and 14 further illustrate the connectors 76 and 77 extend out from the edge of the thermal plates 71 and 72 such that they may overlap the thermal plates when the module fixture 70 is compressed down to the height of h₂. For example, the connector 76 of the bottom component board 79, when compressed, is relatively flush with the thermal plate 71 on top and the connector 77 of the top component board 78 is relatively flush with the thermal plate 72 on the bottom. In this particular embodiment, the connectors 76 and 77 will determine the minimum h₂, or in other words how much the fixture 70 may be compressed. The smaller the fixture 70 may be compressed the smaller the pitch (P) may be between cooling partitions and the higher the density of functional components per rack system, and specifically the universal hardware platform 21 portion of the rack system 10.

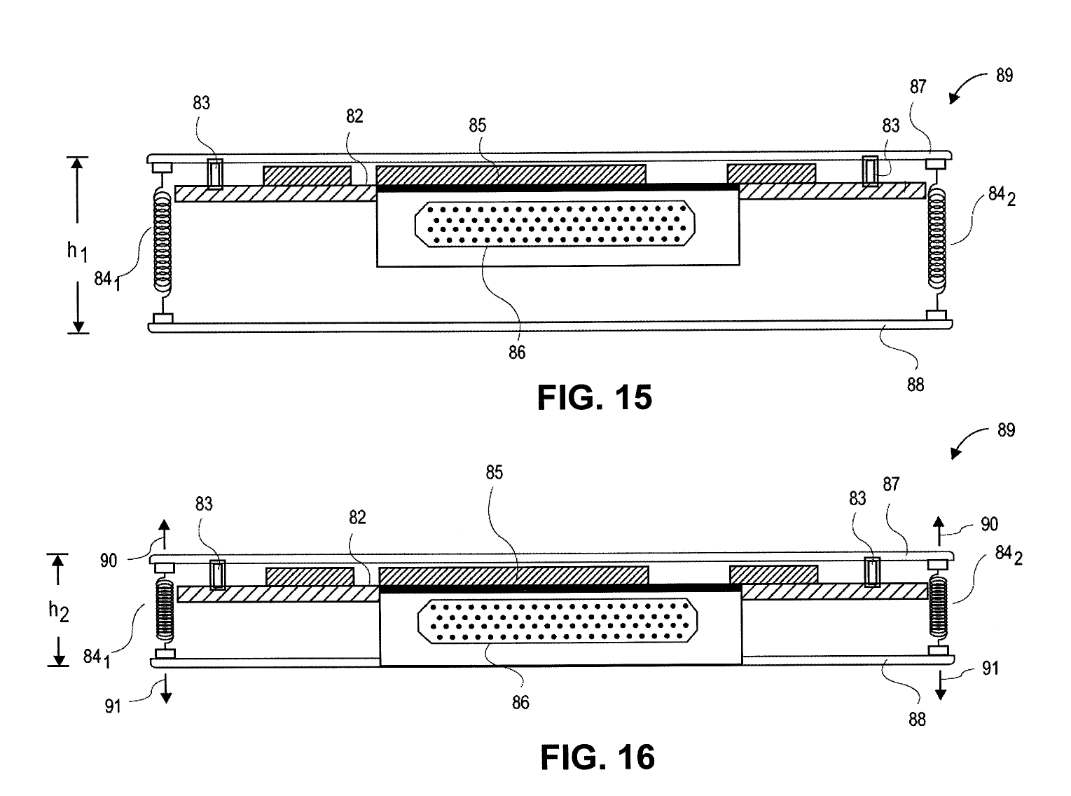

FIGS. 15 and 16 are each embodiments of a module fixture 89 for a rack power board insertable into the rack power section 19 of the rack system 10. The module fixture 89 includes a thermal plates 87 and 88, fasteners 83, tensioners 84₁ and 84₂, component 85, connector 86, and component board 82.

Thus, in a similar way as described above with respect to the module fixture 70 in FIGS. 11 and 12, when the module fixture is inserted into a module bay in the rack power section 19 there is an outward force 90 and an outward force 91 created by the compressed tensioners 84₁ and 84₂. These outward forces provide a physical and thermal contact between the cooled partitions of the rack power section 19 and the thermal plates 87 and 88. Therefore, the component board 82 and components (e.g., component 85) of the module fixture 89 are conductively cooled as coolant flows through the relevant cooled partitions.

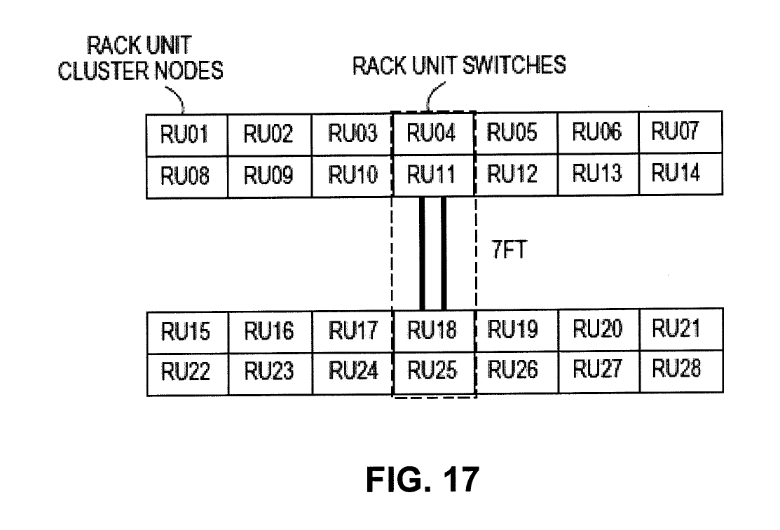

The embodiments described above may provide for compact provision of processing, switching and storage resources with efficient heat removal within a rack system. In some situations, it may be desirable to provide a highly robust computing environment (e.g., a supercomputer) by chaining together resources from multiple rack systems. However, the chaining together of multiple rack systems introduces potential problems in relation to management of the composite system. In an example embodiment, an architecture for providing a robust computing system can be provided by employing a topology as described herein. FIG. 17 illustrates an arrangement of a plurality of rack units (e.g., rack system 10) to provide interconnection thereof for a robust computing environment according to an example embodiment. In this regard, twenty-eight rack units (RU01 to RU28) are provided in two sets of adjacent rows of seven units each. In this example, the sets are shown such that the units in adjacent rows are back to back with approximately seven feet between the two sets. However, any other suitable arrangement could alternatively be provided.

In the example embodiment of FIG. 17, four of the rack units (e.g., RU04, RU11, RU18 and RU25) may be configured as rack unit switches. The twenty four rack units that are not rack unit switches may each be configured with twenty seven cluster units (e.g., instances of cluster unit 28) as rack unit cluster nodes. Meanwhile, the four rack unit switches (e.g., RU04, RU11, RU18 and RU25) may each have four switching units therein. The switching units of each of the four rack unit switches may be utilized to provide central switching functionality to interconnect the remaining rack unit cluster nodes and each other.

In an exemplary embodiment, since each of the rack unit cluster nodes includes twenty seven cluster units, with sixteen network cables (for the corresponding processing modules) leaving each respective cluster unit, there will be 432 cables leaving each rack unit cluster node for networking purposes (e.g., via net 52). Of the 432 cables from each rack unit cluster node, one quarter (or 108) of the cables may be coupled to each respective rack unit switch. Each rack unit switch may then receive 2,592 total cables (108 times 24) corresponding to the respective servers with which each rack unit switch is in communication. Since there are four rack unit switches, this example embodiment includes 10,368 total servers (2,592 times 4) that may be managed or otherwise addressed individually via the rack unit switches.

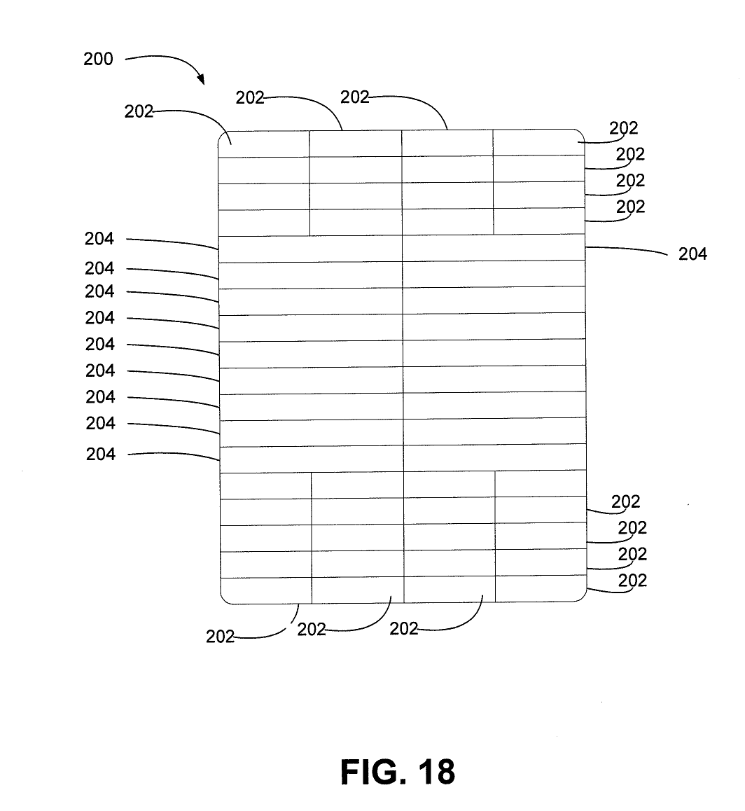

In an exemplary embodiment, each rack unit switch may further include four switch units 200 therein (for a total of sixteen switch units 200 within the system shown in FIG. 17). The switch units 200 may include leaf modules 202 and spine modules 204. An example architecture of the switch unit 200 is shown in FIG. 18. As shown in FIG. 18, the spine modules 204 may be arranged substantially in a two by nine matrix for a total of eighteen spine modules 204. Meanwhile, the leaf modules 202 may be distributed into two matrices including a four by four matrix and a four by five matrix that may be separated from each other by the matrix of spine modules 204 for a total of thirty six leaf modules 202. Other arrangements are also possible.

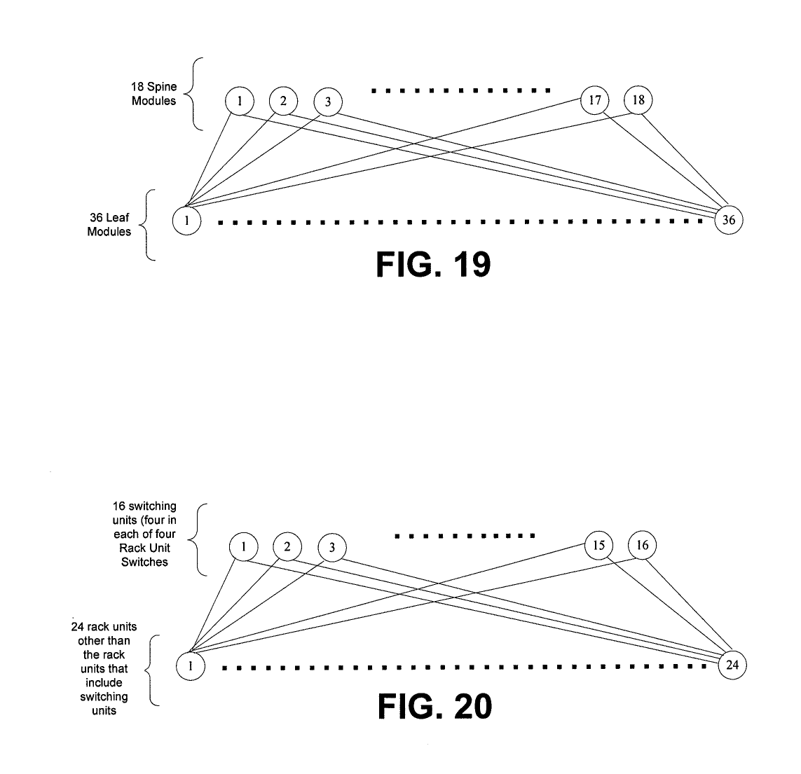

Each of the leaf modules 202 may be connected to each of the spine modules 204 to create a 648 port switch module. FIG. 19 illustrates a potential topology of the switch unit 200 of an example employing a 648 port switch module as described above. As shown in FIG. 19, each of 18 spine modules (e.g., the spine modules 204) that are represented by respective numbered circles (with dots representing some spine modules 204 to simplify the figure to enhance understanding) is connected to each of 36 leaf modules (e.g., leaf modules 202) within each switch unit 200. This topology provides a total of 648 ports that are interconnected in a robust switching network. In other words, each leaf module (e.g., leaf modules 202) includes 18 ports to connect to each respective one of the 18 spine modules (e.g., spine modules 204). Meanwhile, each spine module (e.g., spine modules 204) includes 36 ports to connect to each respective one of the 36 leaf modules (e.g., leaf modules 202). In some embodiments, the 18 ports of the spine modules may connect via the backplane. However, of the 36 ports of the leaf modules 18 may connect via the backplane, while 18 may connect via the front panel.

FIG. 20 illustrates a potential topology for the connection of twenty-four rack units (e.g., RU01 to RU28 other than RU04, RU11, RU18 and RU25) via the four rack unit switches (e.g., RU04, RU11, RU18 and RU25). Since each of the rack unit switches (e.g., RU04, RU11, RU18 and RU25) includes four switch units (e.g., switch unit 200), there are a total of sixteen switch units that are represented by respective numbered circles (with dots representing some switch units to simplify the figure to enhance understanding). The sixteen switch units are each connected to a corresponding one of the twenty-four other rack units. Accordingly, each switch unit includes 24 connections (each of which may be defined my multiple cables such as 27 cables in one example embodiment for a total of 648 ports) to each respective one of the other rack units and each of the other rack units includes 16 connections to each respective one of the sixteen switch units. Using the combination of topologies shown in FIGS. 19 and 20, embodiments of the present invention may be enabled to interconnect, via a robust switching mechanism, every processor within every rack unit in an individually addressable and coherent fashion to define a supercomputer that has robust processing power.

While FIGS. 19 and 20 illustrate one example topology, other topologies such as the dragonfly topology may alternatively be employed. Furthermore, although FIGS. 19 and 20 illustrate an example with 4 rack unit switches and 24 rack units, the principles described with respect to these figures may be generally applied to other embodiments as well. For example, in a computer system with N rack unit switches and 6N processing rack units, where N is a positive integer, each rack unit switch may include four switching units and each switching unit may include at least M²/2 ports. Each processing rack unit may include at least 27*4N ports originating from a plurality of processing modules of each respective processing rack unit. The ports of the N rack unit switches may be coupled to the ports of the 6N processing rack systems to create a network architecture. In such a system, for example, a plurality of cluster switches may be included at each respective processing rack unit (e.g., 27 cluster units each having 8 processing modules with two servers for a total of 432 servers). The switch units of the rack unit switches may each receive 1/N (or ¼ in this example) of the 432 cables from each of the servers of the processing rack unit. Thus, each rack unit switch may receive 108 cables from each of the 24 processing rack units in an example where N=4 such that there are 10,368 total servers that are interconnected via the rack unit switches. The physical architecture of a switching unit may include spine nodes and leaf nodes that are interconnected to each other such that each spine node is directly connected to each leaf node. Cables from the 6N processing rack units may be divided up similarly among the 4N switch units (16 in an example where N=4). In some cases, at least some of the ports of the rack unit switches may be multiplexed (e.g., such that a 6 port connector supports 3 channels for each port to effectively define 18 ports).

Although an embodiment of the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer system comprising:
N rack unit switches, where N is a positive integer, each rack unit switch including four switching units, each switching unit including at least M²/2 ports;
6N processing rack units, each processing rack unit including at least 27*4N ports originating from a plurality of processing modules of each respective processing rack unit, the ports of the N rack unit switches being coupled to the ports of the 6N processing rack systems to create a network architecture.

2. The computer system of claim 1, wherein M equals 36 and N equals 4.

3. The computer system of claim 1, wherein each rack unit includes a network switching element with M ports.

4. The computer system of claim 1, wherein each switching unit includes 648 ports in each rack unit switch.

5. The computer system of claim 4, wherein the computer system includes 10,368 servers, each of which is interconnected via the switching units of the rack unit switches.

6. The computer system of claim 4, wherein the 648 ports in each rack unit switch correspond to 18 spine nodes, each of which is connected to each of 36 leaf nodes.

7. The computer system of claim 6, wherein a first portion of ports of each of the 36 leaf nodes connect to each respective spine node via a backplane and a second portion of the ports of each of the 36 leaf nodes connects to upstream components of the computer system.

8. The computer system of claim 6, wherein all ports of each spine node connect to a backplane assembly of a corresponding rack switch unit, and half of the ports of each leaf node connect to the backplane assembly while a remaining half of the ports of each leaf node connect to a front panel of the corresponding rack switch unit.

9. The computer system of claim 1, wherein respective different ¼ portions of the ports of each processing rack unit are connected to a corresponding one of the four switching units in each of the N rack unit switches.

10. The computer system of claim 1, wherein each rack unit includes 27 cluster units.

11. The computer system of claim 10, wherein each cluster unit includes 16 servers to provide 432 servers per rack unit.

12. The computer system of claim 11, wherein 27 cables from each respective server of the 432 servers of each rack unit are provided to each respective switching unit of the computer system.

13. The computer system of claim 1, wherein each switching unit receives 27*N cables from each of the processing rack units.

14. The computer system of claim 13, wherein N equals 4, such that each switching unit receives 108 cables from each of the processing rack units for a total of 10,368 cables per rack unit switch.

15. The computer system of claim 1, wherein each rack unit switch includes 18 spine nodes and 36 leaf nodes.

16. The computer system of claim 1, wherein each rack unit switch includes a 9 by 2 array of spine nodes.

17. The computer system of claim 16, wherein each rack unit switch includes a 9 by 4 array of leaf nodes.

18. The computer system of claim 16, wherein each rack unit switch includes a 5 by 4 array of leaf nodes and a 4 by 4 array of leaf nodes.

19. The computer system of claim 1, wherein the rack unit switches and the processing rack units each have respective different customized backplanes configured to interface with the respective modules of the corresponding rack unit switches and the processing rack units.

20. The computer system of claim 1, wherein at least some of the ports of the rack unit switches are multiplexed.
